(19) United States
(12) Patent Application Publication
(10) Pub. No.: US 2012/0246705 A1
(43) Pub. Date: Sep. 27, 2012

(54) Object-Based Access Control for Map Data

(75) Inventors: Thomas Daniel Brown, San Francisco, CA (US); Mark Damon Wheeler, Monte Sereno, CA (US); David Anthony Kramer, Santa Barbara, CA (US); John Bernard Newlin, Belmont, CA (US); Vijay Raman, Santa Clara, CA (US)

(73) Assignee: Google Inc., Mountain View, CA (US)

(21) Appl. No.: 13/403,642

(22) Filed: Feb. 23, 2012

Related U.S. Application Data
(60) Provisional application No. 61/445,883, filed on Feb. 23, 2011.

(51) Int. Cl. G06F 21/20

(52) U.S. Cl. 726/4

(57) ABSTRACT

Embodiments allow access to geographic data objects on a per-object basis. A client may send a plurality of requests for geographic data to display within a view frustum. Map data may include a layer with a plurality of assets. Each request may be authenticated by an access control filter, which determines whether the user is authorized to view the data requested.

### CROSS REFERENCE TO RELATED APPLICATIONS

This application claims the benefit of U.S. Provisional Appl. No. 61/445,883 filed Feb. 23, 2011, which is hereby incorporated by reference in its entirety.

### BACKGROUND

1. Field

Embodiments generally relate to access control of geographic data.

2. Background

Geographic project data may be subject to various levels of access control. For example, a user may create a map with a list of locations to be shared with others, using My Maps by Google Inc. of Mountain View, Calif. The user may choose to allow others to read or edit the created data. However, if the user wishes to include other data in her map, such as data obtained from a government agency, she may not be able to add such data, or control and grant access to the other data, if she does not have proper authority.

### BRIEF SUMMARY

Embodiments relate to access control for geographic data on a per-object basis. A method for securing geographic data over a network is disclosed. The method includes receiving a request to access a geographic data over a network. The request includes an authentication token. A geographic data project associated with the requested geographic data object is identified. The geographic data project may include at least two layers of geographic data. An access control list associated with the geographic data project is retrieved. Based on the access control list, at least one access privilege associated with the authentication is determined, and access to the geographic data object is granted when the access privilege allows the access.

Further embodiments, features, and advantages of the invention, as well as the structure and operation of the various embodiments of the invention are described in detail below with reference to accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a diagram of components in accordance with embodiments disclosed herein.

FIG. 2 is a flow diagram of an exemplary method of securing geographic data over a network.

FIG. 3 is an exemplary diagram of a geographic data project.

FIG. 4 is an exemplary user interface.

FIG. 5 is an exemplary system diagram used to implement embodiments disclosed herein.

The drawing in which an element first appears is typically indicated by the leftmost digit or digits in the corresponding reference number. In the drawings, like reference numbers may indicate identical or functionally similar elements.

### DETAILED DESCRIPTION OF EMBODIMENTS

Embodiments authorize requests for map data on a per-object basis. In an example, a client may send a plurality of requests for map data to display within a view frustum. The map data may include a layer with a plurality of assets. Each of the respective requests are authenticated by the access control filter. Once the requests are authenticated, the access control filter may determine whether a user is authorized to view the data requested. The authorization may be determined based on whether the user is in a group authorized to view the map data. Similarly, a request may be authorized to edit map data or an access control list. In this way, embodiments provide request-based access control and data sharing.

Access rights are provided for users of geographic information systems software. Access may be controlled on the administrative and map builder sides as well as named access control to a separate unique ID (such as a Google Account name) may be provided. The named access control can include a specific individual, an entire organization specified by a domain, a collection of groups (which in turn can have individuals specified within them), or the Internet-at-large.

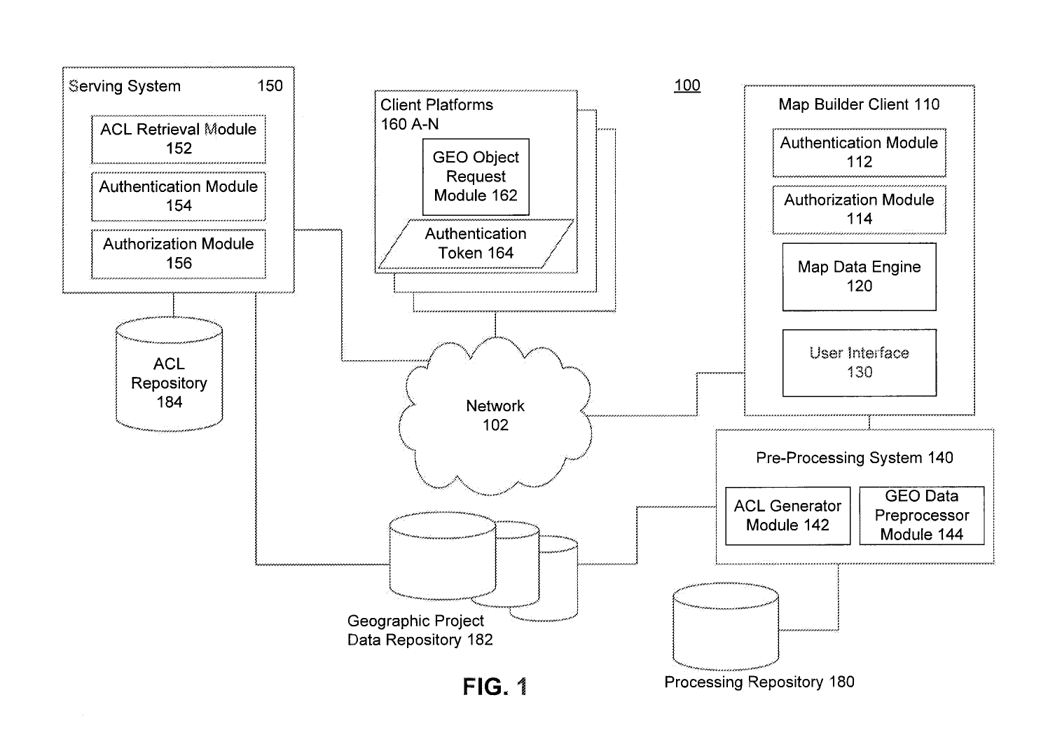

FIG. 1 is a diagram of a system 100 which may be used in embodiments disclosed herein. System 100 may include a network 102. Network 102 may be any suitable network, such as a local area network or wide area network such as the Internet. Network 102 may be wireless, wired, or a combination of the two.

System 100 may also include client platforms 160A-160N, which may be various client devices, such as desktop computers, laptop computers, mobile devices, and the like. Each of client platforms 160A-160N may be configured with one or more geographic request modules 162. Geographic request modules 162 may include, for example and without limitation, a Google Earth client, implemented on a desktop computer, laptop computer, mobile device, or a web browser, such as Google Chrome by Google Inc. of Mountain View, Calif.

Each of client platforms 160A-160N may store an authentication token 164. Authentication token 164 may be associated with a unique ID of a user using a client platform. For example, authentication token 164 may be associated with a user's Google Account name. Request modules controlled by the same user may share one or more authentication tokens.

System 100 may also include one or more geographic project data repositories 182. Geographic project data repositories 182 may be implemented in a database or other persistent storage.

Additionally, map builder client 110, containing authentication module 112, authorization module 114, map data engine 120, and user interface 130, may be connected to network 102. By accessing user interface 130, users may build and publish map projects. User interface 130, in conjunction with map data engine 120, may facilitate various functions, such as uploading of geographic datasets, processing of datasets, and editing geographic information. User interface 130 may also facilitate creating, editing, and assigning of access control lists.

Map builder client 110 may be accessed via any one of client platforms 160A-160N. Map builder client 110 may also contain an authentication module 112. Authentication module 112 may, upon receipt of login information such as a user name and password, authenticate one or more users using geographic request modules 162 implemented on client platforms 160A-160N. Further, authentication module 112 may provide one or each of client platforms 160A-160N with an authentication token 164, such as an HTTP cookie. Authorization module 114 may determine access privileges associated with the authentication token and grant or deny access to a geographic data object based on an access control list retrieved by ACL retrieval module 152, as described below.

System 100 may also include serving system 150. Serving system 150 may operate as the primary device serving geographic project data from geographic project data repositories 182. Serving system 150 may include access control list (ACL) retrieval module 152. ACL retrieval module 152 may receive a request to access a geographic data object including an authenticated user identifier, such as an authentication token 164. ACL retrieval module 152 may communicate with ACL repository 184 to retrieve one or more appropriate ACLs for a given request. ACL repository 184 may be implemented, for example and without limitation, in a database or other persistent storage. Serving system 150 may also include authentication module 154 and authorization module 156. Authentication module 154 may operate in a similar fashion to authentication module 112, and provide one or each of client platforms 160A-160N with an authentication token 164. Authorization module 156 may operate in a similar fashion to authorization module 114 to determine access privileges associated with an authentication token. ACL retrieval module 152 may, in conjunction with authorization module 114 or authorization module 156, grant or deny access to a geographic data object. Serving system 150 may communicate with geographic project data repositories 182 to retrieve geographic project data for a particular request.

ACL repository 184 may communicate over network 102 to pre-processing system 140. Pre-processing system 140 in turn may include ACL generator module 142 and geographic data pre-processing module 144. Pre-processing system 140 may also be connected to processing repository 180, which may be implemented in a database. Processing repository 180 may securely store and manage map asset data and associated metadata. Pre-processing system 140 may also communicate with geographic project data repositories 182 to write or store geographic project data, such as geographic data objects.

Geographic data objects may be created by users, as specified above. Additionally, geographic data objects may be purchased from an outside vendor. Geographic data objects may also be obtained from other sources and stored in geographic project data repository 182.

Geographic project data repository 182 may include heterogeneous data from a variety of sources. For example, repository 182 may include feature or vector data for each geographic data object. Feature data may refer to any geographically-linked features displayed on a map. For example, such features may include, but are not limited to, points of interest, terrain features, region boundaries, man made structures, water bodies, etc. The features may also include any user interface features displayed on a map. Raster data format may represent feature data.

Vector data may refer to points, lines, and polygons that are used to define a map. Furthermore, vector data may also include any data or metadata (e.g., population, area, road surface type etc.) that is associated with one or more map regions. Vector data may include data in Keyhole Markup Language (KML), Geography Markup Language, or other vector data formats.

As a preliminary matter, a user may create a geographic data object containing certain geographic data, such as subway routes for a particular city. Thus, the user may use map builder client 110, by way of user interface 130, to create or upload the data for the geographic data object. Creation of the geographic data object may occur with the assistance of pre-processing system 140 and geographic data pre-processor module 144.

Once the user has created the geographic data object, pre-processing system 140 may allow the user to create an access control list with the help of ACL generator module 142. The created ACL may be stored in ACL repository 184. Pre-processing system 140 may also allow the user to select a previously defined ACL, stored in ACL repository 184, and assign the ACL to the geographic data object to control access to the geographic data object. Creation or selection of an ACL may be assisted by a widget. Additionally, if a user requests publication of the geographic data object, he may be presented with an ACL selection choice.

Each geographic project, which is a collection of geographic data objects, may have an associated ACL.

Access control lists contained by ACL repository 184 may contain a list of approved users, along with the rights possessed by each user. Thus, entries in an ACL may be [user ID, role] pairs. In addition to specifying users, an access control list may specify a group of users associated with a particular organization or domain, a collection of groups, or may grant access to everyone. In order to be granted access to an object, a particular user must be explicitly approved for the particular object via an ACL. Further, shared ACLs are possible. Such a shared ACL may be referenced by other objects to grant the same level of access as the shared ACL.

Access control lists may specify levels of access, or roles, for different types of users. For example, a particular user or group of users may be permitted “peeker” access. Peeker access allows such users to be aware of an object's existence and allows users to examine the object's metadata, such as a thumbnail.

Users may also be granted “reader” access. Reader access allows users to only read particular data. Other users may be granted “writer” access, which allows those users to both read and modify data. Further, a group of users may be granted “owner” access. Those with owner access can create and delete other ACLs, publish databases of geographic information, roll back databases to previous versions, and delete databases. An ACL may also specify that a given user or group have no access, by specifying “none” as the access level. Further access levels may be specified as well.

An organization may use multiple ACLs for many reasons. For example, a governmental organization may use a permissive ACL for accounts of employees. Such an ACL may allow employees to view a large amount of data and edit the data as well. For example, a tax bureau may allow employees to view tax assessments of property, as well as owner information, and update this information whenever necessary. The organization may wish to share a subset of this data with others, such as citizens. However, in order to protect the data from being modified, the ACL for citizens may be set to the reader level. Additionally, citizens may be denied the ability to read all of the data in the map object. For example, to protect privacy, citizens may only be able to see the tax assessments of various property locations but not the owner information. Thus, when creating the geographic data object representing the tax assessment information, the user creating the object may select an ACL to be assigned to the object such that the above access levels are granted.

ACLs may also be nested. Thus, for example, two users may be granted owner access by an ACL named “admins”, such as admins: [joe@example.com OWNER], [bob@example.com OWNER]. Two different users may be granted writer access by another ACL named “editors”, such as editors: [larry@example.com WRITER], [nancy@example.com WRITER]. A third ACL, named “all”, may include a reference to both ACLs, such as all: admins editors. Thus, when creating a particular geographic data object, if a user intends to give access to all four users, he may use the “all” ACL instead of specifying both individual ACLs.

If there are conflicts between ACLs, various precedence rules may take effect. As an example, the most specific match for a given user may control the access given for that user. For example, if the user's exact ID is listed in an ACL, that ACL may take precedence over access granted to the user's exact domain, a partial user's domain, or the entire world.

A user using one of client platforms 160A-N may provide authentication details, such as a username, e-mail address, and/or password, in order to be authenticated. Authentication details may be transmitted over network 102 to map builder client 110. Authentication module 112 of map builder client 110 may accept the authentication details and, in response to the authentication details, may provide one of client platforms 160A-N with an authentication token 164 that identifies the user. The authentication token 164 may be used in accordance with embodiments described herein.

A project may be the result of the pre-processing of any input data associated with that project. Thus, embodiments allow simpler access control. For example, instead of requiring that access be granted to individual objects of the project, such as map data layers, access can be granted on the basis of an entire project, such that the same access is permitted on the various layers of the project.

As explained above, embodiments authorize requests for map data on a per-object basis. A client may send a plurality of requests for map data to display within a view frustum. The map data may include a layer with a plurality of assets. Each of the respective requests are authenticated by the access control filter. Once the requests are authenticated, the access control filter may determine whether a user is authorized to view the data requested. The authorization may be determined based on whether the user is in a group authorized to view the map data. Another user in another group authorized to edit the map data may have edited the map data. In this way, embodiments provide request-based access control and data sharing.

Layers as described herein may refer to geographic data used for various purposes. For example, a layer could include data related to terrain of an area of the Earth. Further, layers could include census or other population data. Layers may also include data related to map styles. Layers may be two-dimensional views or three-dimensional representations.

Each geographic data object used in systems described herein may have an associated access control list. Thus, upon creation of a geographic data object, a user may be provided with a selection to define an access control list for the geographic data object.

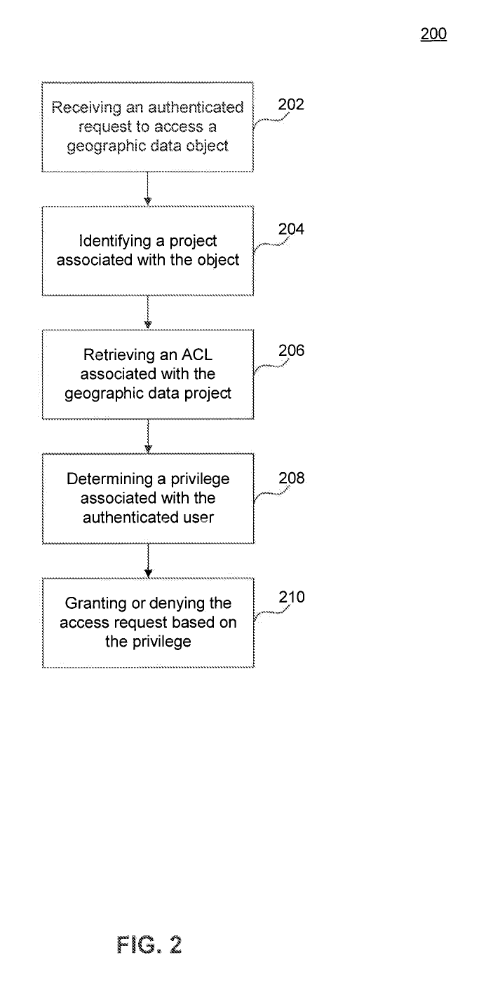

FIG. 2 is a flow diagram of an exemplary method 200 for securing geographic data over a network. At block 202, an authenticated request to access a geographic data object is received. The request may be received from a user who wishes to view an area contained in a view frustum. The authentication request may be received from a user using one of client platforms 160A-N at a server, such as serving system 150. The authenticated request may include an authentication token such as authentication token 164. Such an authentication token may be provided to a user upon providing a correct username, password, or other login credentials. The request may be received over a network, such as network 102.

At block 204, a project associated with the geographic data object is identified. A project may include a collection of two or more layers of geographic data. As above, each layer may include data on various geographic objects or other data. Layers may be stored in geographic project data repository 182.

At block 206, an access control list or ACL associated with the geographic data project is retrieved. The ACL may be retrieved by ACL retrieval module 152. The ACL may be stored in, for example and without limitation, ACL repository 184 of system 100.

At block 208, a privilege associated with the authenticated user is determined. For example, the privilege may be one of peeker, reader, writer or owner, as described herein.

At block 210, based on the privilege determined at block 208, the access request is granted or denied.

As an example, a user test@example.com may navigate an application or client capable of displaying geographic information to a particular view frustum. Examples of applications or clients that are capable of displaying geographic information include, but are not limited to, a Google Earth application and a Google Earth browser plug-in. In order to view the various geographic object data contained in the view frustum, the client may request one or more geographic data objects. Each geographic data object may be part of a geographic data project. An ACL associated with the project is retrieved. The ACL may contain an entry for the user, or for a group associated with the user. Based on the ACL associated with the user, access to the various geographic data objects that the user has access to may be granted to the user. Access to other geographic data objects may be denied in accordance with the various ACLS.

In an embodiment, the geographic data object requested at block 202 may include multiple layers. Each of the layers of the geographic data object may be rendered according to a map style. For example, a style may define how to render a road defined in map vector data. As detailed above, layers containing geographic data may be stored in geographic project data repository 182.

In an embodiment, the geographic data object may be rendered as a two-dimensional map. The two-dimensional map may display street names and other data to assist a user in navigating the geographic data object. The geographic data object may also be rendered as a three-dimensional map. Thus, terrain data may be apparent, or building height may be visible, depending on the three-dimensional map used.

In an embodiment, the access control list of block 206 may be associated with a plurality of geographic data projects. Each of the geographic data projects may include two or more layers of geographic data, as described herein.

The geographic data project of block 202 may include data stored in a plurality of data sources. Thus, for example, street data may be stored in a data source controlled by a transportation department. Data relevant to water pipes may be stored in a data source controlled by the water department of a jurisdiction.

Determining a privilege associated with a user at block 208 may include two steps. First, the authentication token received at block 202 may be associated with a domain The domain may indicate the company or other organization associated with the data requestor. Once the domain associated with the authentication token is determined, at least one access privilege associated with the domain is determined. The access request may then be granted or denied.

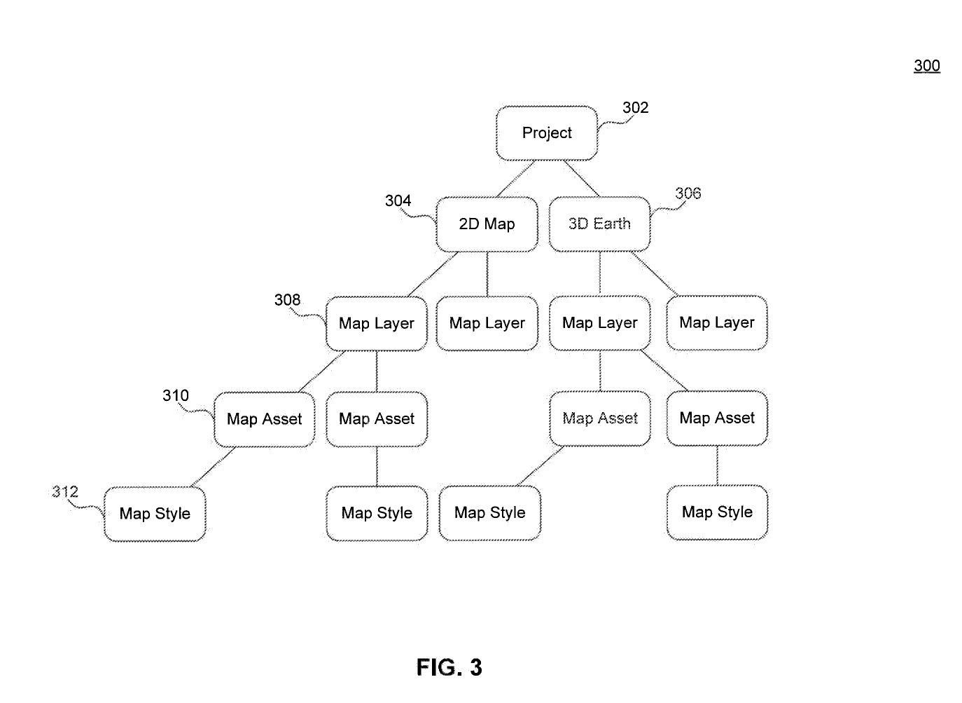

FIG. 3 is an exemplary structure of a geographic data project 302. Such a geographic data project 302 may have been created with the assistance of map builder client 110 and pre-processing system 140. Project 302 may have an associated ACL.

Geographic data project 302 may include two renderings 304 and 306. Rendering 304 may display the components of geographic data project 302 as a two dimensional map. Rendering 306 may display components of geographic data project 302 as a three dimensional earth representation. In this way, data project 302 may be utilized on multiple different client platforms.

Each rendering 304 and 306 may include two or more layers 308 of geographic data. Each layer of geographic data 308 may contain one or more map assets 310. Map assets 310 may be geographic data or map data, such as subway data, water line data, or any other geographic data that may be used. In an embodiment, each map asset 310 may have an associated map style 312 that controls the presentation of the map asset 310.

In an embodiment, each map asset 310 may have an associated access control list. Thus, when creating a map asset 310, by way of map builder client 110, pre-processing system 140 may work in conjunction with ACL generator module 142 to create an ACL for the particular map asset. In a further embodiment, project 302 may have a single access control list associated with the entire project, including any associated layers, assets, and styles.

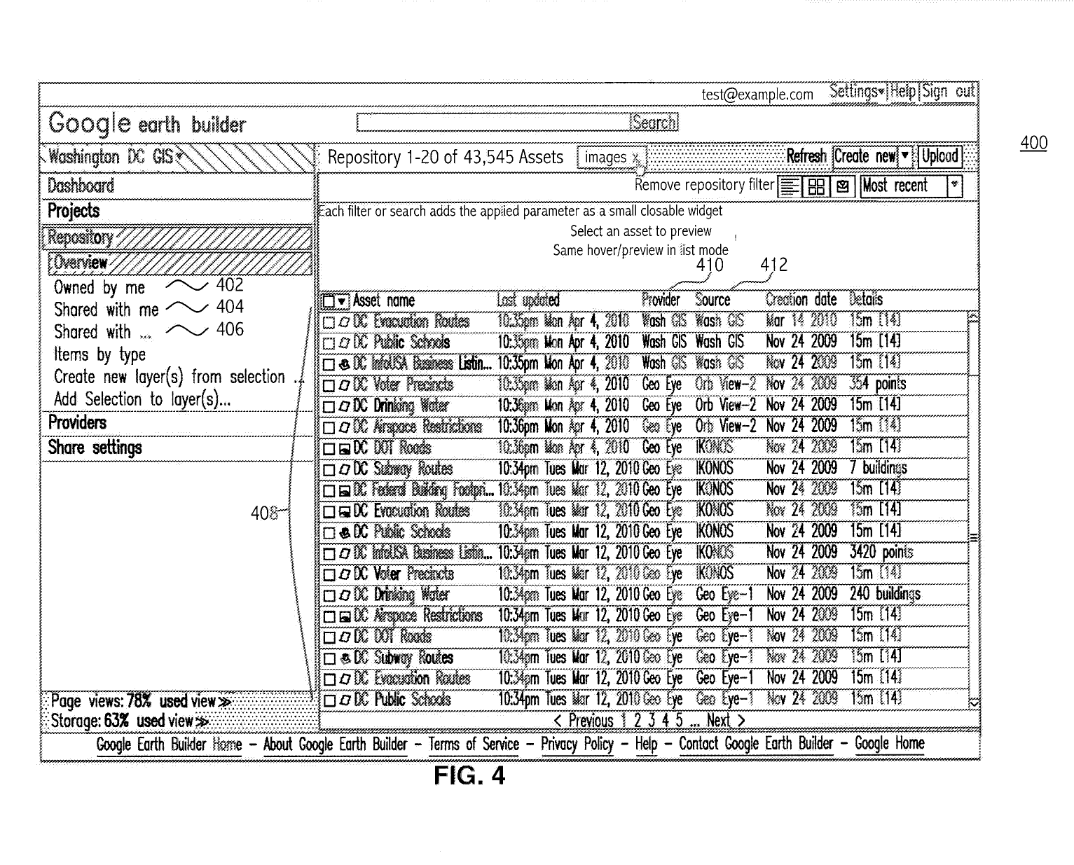

FIG. 4 is an exemplary user interface 400 that may assist in understanding embodiments. Upon clicking link 402 of user interface 400, display area 408 may display repositories owned by the currently logged-in user, test@example.com. Thus, if the user were to click on link 402, a list may appear of repositories created and owned by the user. Such repositories may have an associated ACL entry such as [test@example.com OWNER]. Thus, because the specified user has owner access, he may grant or deny access to other users.

Upon clicking link 404 of user interface 400, display area 408 may display repositories that are shared with the currently logged in user. Such repositories may have been created by other users in the organization, or may have been created and purchased by the organization. Such repositories may have an associated ACL entry such as [test@example.com READER] or [test@example.com WRITER].

Upon clicking link 406 of user interface 400, display area 408 may display repositories that are owned by the logged-in user and shared with other users. Users who have access may be denoted by an full user ID, a domain, sub-domain, or a group. Thus, an ACL entry for such repositories may read [test@example.com OWNER], [example.com READER], [jim@example.com WRITER].

Display area 408 lists various assets or repositories that are available to the user. Each entry in display area 408 may list pertinent information about the repository, such as the name of the repository, the last time the repository was updated, the provider and source, the creation date, and further details. For example, the provide of each repository may be specified by column 410. The source of each repository may be specified by column 412.

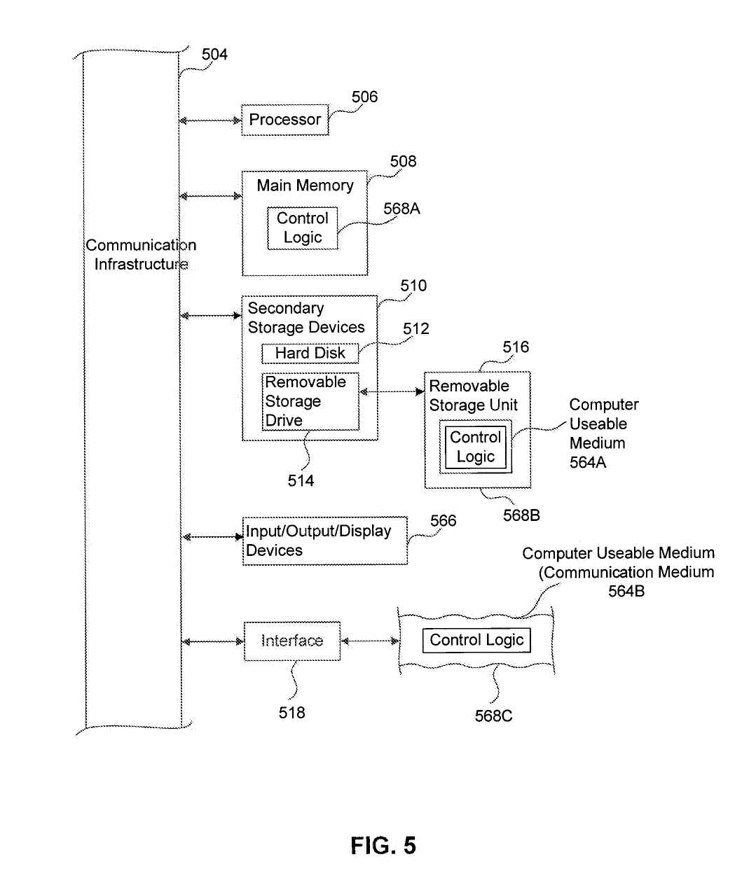

In an embodiment, the system and components of embodiments described herein are implemented using well known computers, such as example computer 502 shown in FIG. 5. For example, map builder client 110 and/or client platforms 160A-N may be implemented using computer(s) 502.

Computer 502 can be any commercially available and well known computer capable of performing the functions described herein, such as computers available from International Business Machines, Apple, Sun, HP, Dell, Compaq, Cray, etc. Computer 502 can also be any commercially available and well known tablet, mobile device or smart-phone capable of performing the functions described herein, such as devices available from Apple, HTC, RIM, Nokia, Sony, etc.

Computer 502 may include one or more processors (also called central processing units, or CPUs), such as a processor 506. Processor 506 may be connected to a communication infrastructure 504.

Computer 502 may also include a main or primary memory 508, such as random access memory (RAM). Primary memory 508 may have stored therein control logic 508A (computer software), and data.

Computer 502 may also include one or more secondary storage devices 510. Secondary storage devices 510 may include, for example, a hard disk drive 512 and/or a removable storage device or drive 514, as well as other types of storage devices, such as memory cards and memory sticks. Removable storage drive 514 represents a floppy disk drive, a magnetic tape drive, a compact disk drive, an optical storage device, tape backup, etc.

Removable storage drive 514 may interact with a removable storage unit 516. Removable storage unit 516 may include a computer useable or readable storage medium 520 having stored therein computer software 522 (control logic) and/or data. Removable storage unit 516 may represent a floppy disk, magnetic tape, compact disk, DVD, optical storage disk, or any other computer data storage device. Removable storage drive 514 may read from and/or write to removable storage unit 516 in a well known manner.

Computer 502 may also include input/output/display devices 524, such as monitors, keyboards, pointing devices, Bluetooth devices, etc.

Computer 502 may further include a communication or network interface 518. Network interface 518 may enable computer 502 to communicate with remote devices. For example, network interface 518 may allow computer 502 to communicate over communication networks or mediums 528 (representing a form of a computer useable or readable medium), such as LANs, WANs, the Internet, etc. Network interface 518 may interface with remote sites or networks via wired or wireless connections.

Control logic 526 may be communicated to and from computer 502 via communication medium 528.

Any tangible apparatus or article of manufacture comprising a computer useable or readable medium having control logic (software) stored therein is referred to herein as a computer program product or program storage device. This may include, but is not limited to, computer 502, main memory 508, secondary storage devices 510. Such computer program products, having control logic stored therein that, when executed by one or more data processing devices, cause such data processing devices to operate as described herein, represent the embodiments.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Each of client platforms 160A-160N, map builder client 110, pre-processing system 140, or serving system 150 may be implemented on any computing device. Such computing device can include, but is not limited to, a personal computer, mobile device such as a mobile phone, workstation, embedded system, game console, television, set-top box, or any other computing device. Further, a computing device can include, but is not limited to, a device having a processor and memory for executing and storing instructions. Software may include one or more applications and an operating system. Hardware can include, but is not limited to, a processor, memory and graphical user interface display. The computing device may also have multiple processors and multiple shared or separate memory components. For example, the computing device may be a clustered computing environment or server farm.

Each of client platforms 160A-160N, map builder client 110, pre-processing system 140, or serving system 150 may be implemented in hardware, software, firmware, or any combination thereof.

Each of processing repository and geographic project data repository may be any type of structured memory, including a persistent memory. In examples, each database may be implemented as a relational database.

The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A computer-implemented method for securing geographic data over a network, comprising:
(a) receiving, over the network, a request to access a geographic data object, the request including an authentication token;
(b) identifying a geographic data project associated with the requested geographic data object, the geographic data project including at least two layers of geographic data;
(c) retrieving an access control list associated with the geographic data project;
(d) determining at least one access privilege associated with the authentication token from the access control list; and
(e) when the access requested is allowed by the at least one access privilege, authorizing the request to access a geographic data object.

2. The method of claim 1, wherein at least one of the layers in the geographic data project includes an asset that can be rendered according to a map style.

3. The method of claim 1, wherein the geographic data object can be rendered for a two-dimensional map or a three-dimensional map.

4. The method of claim 1, wherein the ACL is associated with a plurality of geographic data projects, each geographic data project including at least two layers of geographic data.

5. The method of claim 1, wherein the ACL is associated with a plurality of geographic data projects, each geographic data project including at least two layers of geographic data.

6. The method of claim 1, wherein the geographic data project includes data stored in a plurality of different data sources.

7. The method of claim 1, wherein the determining (d) comprises:
(i) determining a domain associated with the authentication token;
(ii) determining the at least one access privilege to be associated with the domain.

8. The method of claim 1, wherein the determining (d) comprises:
determining a group associated with the authentication token;
(ii) determining the at least one access privilege to be associated with the group.

9. A system for securing geographic data over a network, comprising:
a geographic data repository that stores a geographic data project including at least two layers of geographic data;
an ACL retrieval module that receives, over the network, a request to access a geographic data object associated with the geographic data project, the request including an authentication token, and retrieves an access control list associated with the geographic data project;
an authentication module that determines at least one access privilege associated with the authentication token from the access control list, and, when the access requested is allowed by the at least one access privilege, authorizes the request to access the geographic data object.

10. The system of claim 9, wherein at least one of the layers in the geographic data project includes an asset that can be rendered according to a map style.

11. The system of claim 9, wherein the geographic data object can be rendered for a two-dimensional map or a three-dimensional map.

12. The system of claim 9, wherein the ACL is associated with a plurality of geographic data projects, each geographic data project including at least two layers of geographic data.

13. The system of claim 9, wherein the ACL is associated with a plurality of geographic data projects, each geographic data project including at least two layers of geographic data.

14. The system of claim 9, wherein the identifying a geographic data project includes data stored in a plurality of different data sources.

15. The system of claim 9, wherein the authentication module determines a domain associated with the authentication and determines the at least one access privilege to be associated with the domain.

16. The system of claim 9, wherein the determining (d) comprises:
(i) determining a domain associated with the authentication token;
(ii) determining the at least one access privilege to be associated with the domain.

17. The system of claim 9, wherein the determining (d) comprises:
(i) determining a group associated with the authentication token;
(ii) determining the at least one access privilege to be associated with the group.

18. A computing device, comprising:
a network interface; and
processor hardware connected to the network interface,
the processor hardware configured to receive, via the network interface, a request for a geographic data object and, in response to the request, grant or deny access to the geographic data object according to an access control list associated with a project that contains the geographic data object.

19. The computing device of claim 18, wherein the processor hardware is configured to identify an authentication token associated with the request and to grant or deny access to the geographic data object based on comparing the authentication token to the access control list.

20. The computing, device of claim 19, wherein the processor hardware is included in a server further configured to access the geographic data object from a geographic data repository and provide the geographic data object to a client that provided the request for the geographic data object.
